(19) United States
(12) Patent Application Publication
(10) Pub. No.: US 2004/0056636 A1
(43) Pub. Date: Mar. 25, 2004

(54) Portable power supply having replaceable rechargeable battery for video game machine

(75) Inventor: Kent T.J. Hsu, Taipei (TW)

Correspondence Address: RABIN & BERDO, P.C., Suite 500, 1101 14 Street, N.W., Washington, DC, 20005, US

(73) Assignee: ASOKA INC, Taipei (TW)

(21) Appl. No.: 10/251,818

(22) Filed: Sep. 23, 2002

(51) Int. Cl. H02J 7/00

(52) U.S. Cl. 320/107

(57) ABSTRACT

A portable power supply for a video game machine such as Sony PS I mounted thereon is provided. The power supply comprises a charger, a replaceable rechargeable battery fastened in and electrically couple to the charger, and a soft protective cover shaped to conform to and secure to the received charger. The invention has further advantages of securing and protecting components and prolonging a playing time of the video game machine in an outdoor place.

### FIELD OF THE INVENTION

The present invention relates to power supplies and more particularly to a portable power supply having a replaceable rechargeable battery adapted to be used in a video game machine such as Sony PS I.

### BACKGROUND OF THE INVENTION

Conventionally, a video game machine is played at home or an indoor amusement place rather than outdoors. Thus, such video game machine is limited in applications. For solving this problem, a portable video game machine is developed. The video game machine has a builtin screen. Further, a portable power supply is provided for outdoor use.

For Sony PS I, a typical charger therefor comprises a boultin rechargeable battery having a charger circuit in a bottom. The charger circuit has one end coupled to a power plug for plugging to an outlet for charging to the charger and the other end coupled to the video game machine for supplying power thereto. Hence, a user can carry a charged charger for supplying power to the video game machine for outdoor use.

However, the prior art suffered from several disadvantages. For example, when the rechargeable battery in the charger is discharged, the user has to find a power source for charging the rechargeable battery. This is not feasible in an outdoor place. Moreover, the charger has to be discarded if the rechargeable battery is malfunctioned since the rechargeable battery is not replaceable. This is a waste. Further, the cost borne on a consumer is increased. In addition, typically the charger has two upper hooks caught on two holes on the machine's rear panel. However, such fastening is not reliable. In fact, they are susceptible of disengagement. Also, such holes may be reserved for securing to a screen if there is such screen provided on the machine. Thus improvement exists.

### SUMMARY OF THE INVENTION

It is therefore an object of the present invention to provide a portable power supply for a video game machine mounted thereon comprising a charger comprising an internal charger circuit, a plurality of vent openings on both a top and a bottom, a power plug on a side, a line coupled to the video game machine for supplying power thereto, a parallelepiped receiving space a charge indicator, a power indicator both on an opposite side, and two terminals on a side of the receiving space, the terminals being electrically coupled to the charger circuit; a parallelepiped replaceable rechargeable battery received in the receiving space, the rechargeable battery comprising two side electrodes electrically coupled to the terminals for being charged therefrom, two tabs adjacent the electrodes, the tabs being flexible for fixing the rechargeable battery in the receiving space, and two latches on bottoms of the tabs, the latches being caught on the side of the receiving space for securing the rechargeable battery to the charger; and a soft protective cover comprising a bottom containing space shaped to conform to and receive the charger, a plurality of openings disposed corresponding to the rechargeable battery, the vent openings, the charge indicator, and the power indicator respectively, and two top trims for restraining the received charger and the video game machine from disengagement. By utilizing the invention, not only the drawbacks of the prior art are eliminated but also a plurality of advantages are obtained. For instance, components are secured and protected by the protective cover. Also, it is portable for being adapted to outdoor use. Further, a prolonged playing time of the video game machine in an outdoor place is made possible.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of a portable power supply for video game machine according to the invention;

FIG. 2 is an exploded perspective view of FIG. 1;

FIG. 3 is an exploded perspective view of charger, rechargeable battery, and protective cover; and

FIG. 4 is a perspective view of the portable power supply with a video game machine mounted thereon.

### DETAILED DESCRIPTION OF THE PREFERRED EMBODIMENTS

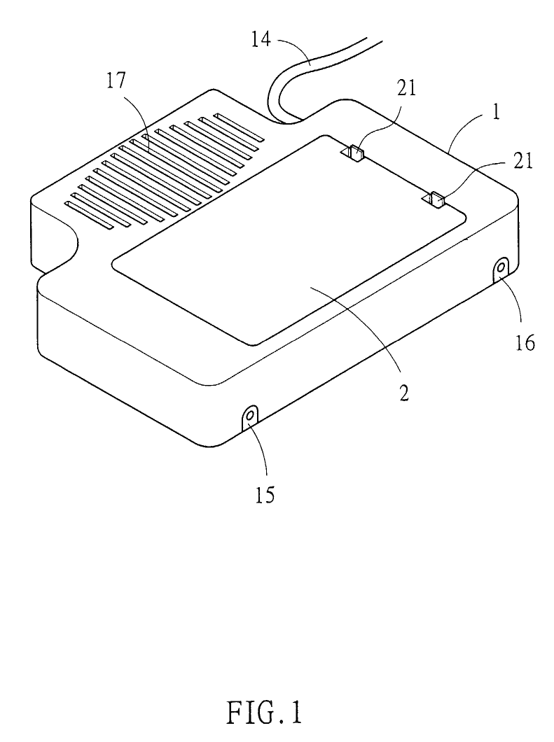

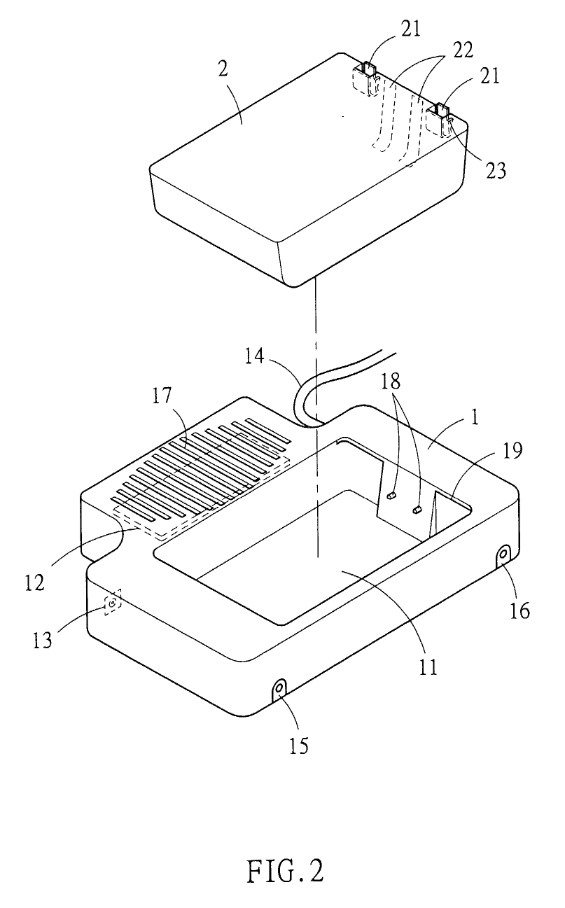

Referring to FIGS. 1, 2 and 3, there is shown a portable power supply for video game machine in accordance with the invention comprising a charger 1, a rechargeable battery 2, and a protective cover 3. Each of above components will now be described in detail below.

The charger 1 comprises an internal charger circuit 12 in a rear, a plurality of vent openings 17 on both top and bottom, a power plug 13 on a side for coupling to an outlet via a power cord for charging, a line 14 coupled to a video game machine (not shown) for supplying power thereto, a parallelepiped receiving space 11, two terminals 18 on a side of the receiving space 11, the terminals 18 being electrically coupled to the charger circuit 12, a charge indicator 15 on an opposite side, the charge indicator 15 being lit during charging, and a power indicator 16 on the same side as the charge indicator 15, the power indicator 16 being lit when power is being supplied to the video game machine through the line 14.

The rechargeable battery 2 is a parallelepiped received in the receiving space 11. The rechargeable battery 2 comprises two side electrodes 22 electrically coupled to the terminals 18 for being charged therefrom, two tabs 21 adjacent the electrodes 22, the tabs 21 being flexible for fixing the rechargeable battery 2 in the receiving space 11, and two latches 23 on the bottoms of the tabs 21, the latches 23 being caught on a projected edge 19 of the receiving space 11 for securing the rechargeable battery 2 to the charger 1.

Note that the rechargeable battery 2 is replaceable. Hence, there is no need to discard both the rechargeable battery 2 and the charger 1 if the rechargeable battery 2 is malfunctioned. To the contrary, in a replacement operation, a user simply pushes the tabs 21 outward to remove the discharged rechargeable battery 2. This has the advantages of saving resources and reducing the cost borne on a consumer. Further, a user can prepare a plurality of charged rechargeable batteries 2 prior to outing. When the installed rechargeable battery 2 is low a simple replacement of a new one is sufficient. This can prolong a playing time of the video game machine. Thus, this is very convenient.

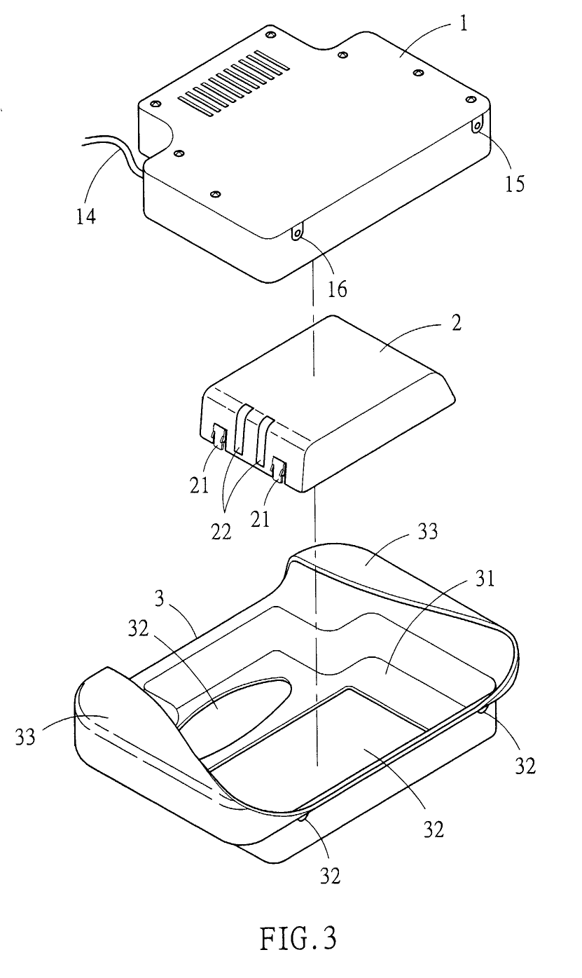

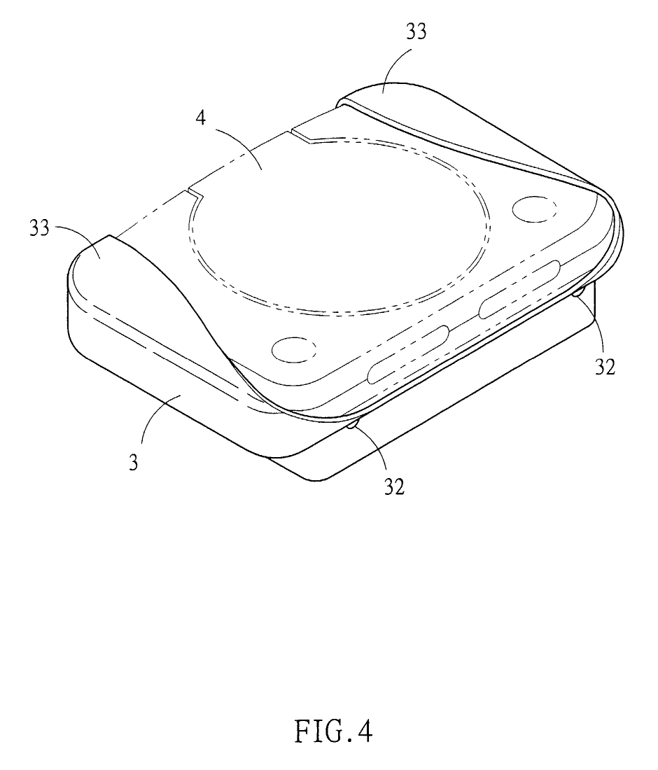

Referring to FIG. 4 in conjunction with FIG. 3, there is also provided a soft protective cover 3. The protective cover 3 comprises a bottom receiving space 31 shaped to conform to the charger 1 so as to receive the charger 1 (including the rechargeable battery 2) therein, a plurality of openings 32 disposed corresponding to the rechargeable battery 2, the vent openings 17, the charge indicator 15, and the power indicator 16 respectively for exposing them, and two top trims 33 for restraining the received charger 1 and a video game machine 4 from disengagement. In detail, the receiving space 11 is disposed at a lower side (i.e., the bottom receiving space 31) of the protective cover 3. The rechargeable battery 2 may be either installed in the receiving space 11 in advance or inserted into the receiving space 11 through the corresponding opening 32. Next, place the video game machine 4 on the top of the charger 1 by slightly bending the trims 33. This is a complete assembly of a portable power supply and a video game machine. Hence, a number of advantages are obtained. For example, components are secured and protected by the protective cover 3. Also, it is portable for being adapted to outdoor use.

While the invention has been described by means of specific embodiments, numerous modifications and variations could be made thereto by those skilled in the art without departing from the scope and spirit of the invention set forth in the claims.

What is claimed is:

1. A portable power supply for a video game machine mounted thereon comprising:
a charger comprising an internal charger circuit, a plurality of vent openings on both a top and a bottom, a power plug on a side, a line coupled to the video game machine for supplying power thereto, a parallelepiped receiving space, and two terminals on a side of the receiving space, the terminals being electrically coupled to the charger circuit;
a parallelepiped replaceable rechargeable battery received in the receiving space, the rechargeable battery comprising two side electrodes electrically coupled to the terminals for being charged therefrom, two tabs adjacent the electrodes, the tabs being flexible for fixing the rechargeable battery in the receiving space, and two latches on bottoms of the tabs, the latches being caught on the side of the receiving space for securing the rechargeable battery to the charger; and
a protective cover comprising a bottom containing space shaped to conform to and receive the charger, a plurality of openings disposed corresponding to the rechargeable battery and the vent openings, and two top trims for restraining the received charger and the video game machine from disengagement.

2. The portable power supply of claim 1, wherein the charger further comprises a charge indicator and a power indicator both on an opposite side.

3. The portable power supply of claim 1, wherein the protective cover is formed of a soft material.

4. The portable power supply of claim 2, wherein two of the openings are disposed corresponding to the charge indicator and the power indicator respectively.
